(19) United States
(12) Patent Application Publication
(10) Pub. No.: US 2014/0131228 A1
(43) Pub. Date: May 15, 2014

(54) Silicone-Based Building Material, Building Kit, and Method

(71) Applicant: Fermín Návar, Austin, TX (US)

(72) Inventor: Fermín Návar, Austin, TX (US)

(21) Appl. No.: 13/674,921

(22) Filed: Nov. 12, 2012

(51) Int. Cl. C04B 24/28; B65D 81/32

(52) U.S. Cl. CPC C04B 24/28; B65D 81/32
USPC 206/219; 524/3; 156/60

(57) ABSTRACT

A method of forming a flexible building material includes adding a silicone rubber base material to a mixer in a quantity of 10 parts by weight and adding a curing agent to the mixer in a quantity of less than two parts by weight. The method further includes selectively adding a granular material to the mixer and mixing the silicone rubber base material, the curing agent, and the granular material to form a flexible building material.

### FIELD

The present disclosure is generally related to flexible silicone-based concrete and mortar materials for use in construction, such as in grout, mortar, concrete seal, and other applications. More particularly, the present disclosure relates to flexible silicone-based concrete and mortar materials that are resistant to breakdown in the presence of water.

### BACKGROUND

A common, conventional construction material is concrete, and it is used in a variety of places due to its high strength as well as its wear and abrasion resistance. Over time, environmental conditions and use cause these construction materials to wear, abrade, crack or otherwise degrade, thus necessitating repair or replacement to restore them to their original condition. For example, concrete is at least partially permeable, allowing moisture to penetrate surface layers. In some instances, such penetration can lead to cracking and/or heaving of portions of the concrete.

Similarly, mortar is often used to seal gaps between tiles, stones, bricks, and other construction materials, in part, because mortar is durable. Unfortunately, like concrete, mortar is susceptible to moisture penetration and can breakdown over time due to exposure to the elements.

If the same or a similar material is utilized to patch holes or cracks in concrete or mortar, the patching material can shrink upon curing, disengage from the adjacent surfaces, and become dislodged. For this reason, specialty cement and concrete repair materials have been developed. For example, elastomeric forms, poured or injected thermoplastics and/or elastomeric fill materials have been used to patch cracks in concrete. The most common joint filler has been hot melt asphalt, which tends to fail over time due to hardening from aging or from temperature variations.

### SUMMARY

In an embodiment, a building material kit includes a first container to hold a silicone rubber base material, a second container to hold a curing agent; and a third container to hold a granular material. The silicone rubber base material, the curing agent, and the granular material are configured to be mixed to form a flexible building material.

In another embodiment, a method of forming a flexible building material includes adding a silicone rubber base material to a mixer in a quantity of 10 parts by weight and adding a curing agent to the mixer in a quantity of less than two parts by weight. The method further includes selectively adding a granular material to the mixer and mixing the silicone rubber base material, the curing agent, and the granular material to form a flexible building material. In an embodiment, a surface spray may be applied to a substrate prior to application of the flexible building material to assist in adhering the building material to the substrate.

In still another embodiment, a silicone mortar includes a silicone rubber base in a quantity of approximately ten parts by weight, a curing agent in a quantity of approximately one to three parts by weight, and a granular material in a quantity of at least one part by weight.

### BRIEF DESCRIPTION OF THE DRAWINGS

FIG. 1 is a flow diagram of an embodiment of a method of forming a flexible silicone-based building material including silicone rubber and a granular material.

FIG. 2 is a cross-sectional view of an example of a structure including the flexible silicone-based building material formed using the method of FIG. 1 used as a mortar between flooring material.

FIG. 3 is a cross-sectional view of a second example of a structure including the flexible silicone-based building material used as a mortar and including granular material.

FIG. 4 is a cross-sectional view of a third example of a structure including the flexible silicone-based building material used as a mortar and including a surface coating.

FIG. 5 is cross-sectional view of a fourth example of a structure including the flexible silicone-based building material used as a mortar and configured to bond to a vertical substrate.

FIG. 6 is a flow diagram of an embodiment of a method of using the flexible silicone-based building material.

In the following discussion, the same reference numbers are used in the various embodiments to indicate the same or similar elements.

### DETAILED DESCRIPTION OF ILLUSTRATIVE EMBODIMENTS

Examples of a silicone composition are described below that include a silicone base configured to vulcanize at room temperature, a catalyst, and granular material (such as stones, stone fragments, sand, powders or other particulates) that can be mixed to form a silicone composition. The silicone composition can be used as a flexible mortar or concrete material building material or can be applied to bond a building material to a substrate or structure of the same or different composition. The silicone composition can be used in a variety of construction applications, such as in securing stones to a fireplace structure, sealing gaps between bricks, filling between flagstones on a back porch or along the sides of a pool, or even in lieu of concrete. The silicone composition can also be used in in civil and industrial engineering projects, such as in repairing cracks and fractures in road surfaces, providing expansion joints between stones, and so on.

The silicone base and catalyst can be referred to as an addition cure or hydrosilylation cure, which involves the addition of a silicon hydride (SiH) to an unsaturated carbon-carbon bond in the presence of a noble metal catalyst (such as Platinum). The silicone rubber base includes a silicon hydride-functional crosslinker and an inhibitor to provide working time once the catalyst has been mixed with the base. This type of RTV silicone rubber produces no odors or byproducts. In particular, such silicone polymers do not have many extra groups to flash off. Accordingly, the composition is not exothermic and does not release odorants. Further, the silicone rubber composition is water resistant and maintains its hardness and tensile strength over a wide range of temperatures. Further, by selecting particulates for mixing with the silicone base material, color, texture, and compressibility of the compound may be controlled. In particular, the size of the particulates or granular material may be selected to increase hardness and reduce compressibility of the compound while maintaining some degree of flexibility. Additionally, the choice of silicone rubber and the ratio of the parts per weight of silicone rubber base relative to catalyst may be selected to provide a desired curing time and a desired hardness or durometer parameter. Different silicone rubbers may have different durometer/hardness readings and also possibly different ratios of curing agent and different cure times. Accordingly, the specific types of silicone rubber and catalyst may be selected by a user to produce a suitable building material for a particular environment.

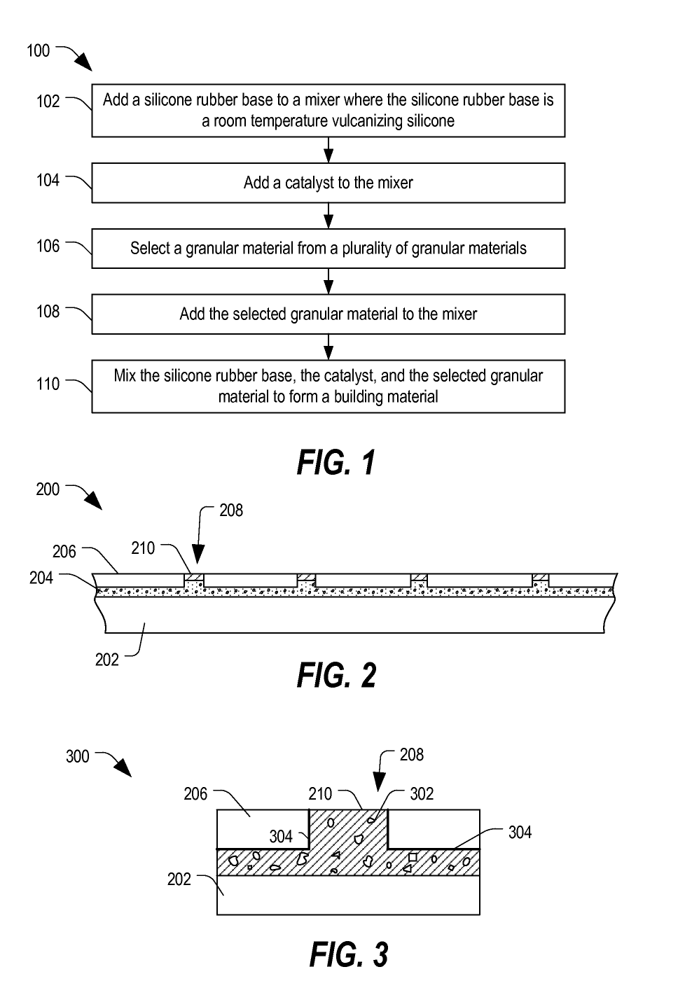

FIG. 1 is a flow diagram of an embodiment of a method 100 of forming a flexible silicone-based building material including silicone rubber and a granular material. At 102, a silicone rubber base is added to a mixer, where the silicone rubber base is a room temperature vulcanizing silicone. The silicone rubber base may be any room temperature vulcanizing (RTV) silicone rubber base that can be combined with a catalyst to form a silicone compound that hardens into a flexible seal. In an example, the silicone rubber base may include a silicon hydride-functional crosslinker and an inhibitor that allows time for application of the compound after the catalyst is added. One possible example of a suitable silicone rubber base is a Silastic® T-4 RTV Silicone rubber base that is commercially available from Dow Corning Corporation of Midland, Mich.

Advancing to 104, a catalyst is added to the mixer. The catalyst may be any chemical mixture that, when combined with the silicone rubber base, produces a hydrosilylation cure. In an example, the catalyst includes a noble metal catalyst (such as Platinum). One possible example of a suitable catalyst is a Silastic® T-4/T-4 O Curing Agent that is commercially available from Dow Corning Corporation of Midland, Mich. Continuing to 106, a granular material may be selected from a plurality of granular materials. Such granular material may include sand, rocks, rock chips, concrete, or other material. Such granular material may be selected according to desired color, size, shape, or any combination thereof.

Moving to 108, the granular material is added to the mixer. Proceeding to 110, the silicone rubber base, the catalyst and the selected granular material are mixed to form a building material (or composition). In general, the silicone rubber base and the catalyst may cure to form a substantially transparent or clear building material. The granular material may be used to add texture, color or both to the building material, making it possible to substantially match the look and feel of the building material to surrounding materials, such as stones, bricks, concrete, or other materials.

In a particular example, the silicone rubber base and the catalyst may be mixed at a ratio of ten parts per weight of silicone rubber base to one-to-three part per weight of the catalyst (depending on the suitable or appropriate cure time, hardness, etc. and/or depending on the type of silicone rubber/catalyst admixture selected), with at least one part per weight of granular material added. The amount of granular material added may be selected to impart a suitable texture or appearance. In some instances, such as in a high traffic environment, more granular material may be added to provide a suitable texture and to reduce compressibility. In other examples, the parts per weight of the silicone rubber base and the catalyst may be adjusted. In particular, the ratio will change depending on the type of durometer silicone and curing agent used.

The resulting building material cures and hardens over a period of time, such as 24 to 48 hours. Once the material is mixed, a user may have between 30 minutes and 120 minutes to work the material onto the surface area being applied. During this time, the building material may be deployed as grout, placed between objects as a mortar and/or adhesive, or otherwise placed into use. Additionally, during this period, the user may press additional granular material into an exposed area of the building material to add texture to the material and/or to further match the building material to surrounding surfaces. Further, in some instances, the exposed area may be dusted with powdered material, such as concrete dust, sand, stone dust, chalk, and the like to soften the appearance of the material and/or to match or contrast with surrounding materials. One possible example of the building material used as a grout is described below with respect to FIG. 2.

FIG. 2 is a cross-sectional view of an example of a structure 200 including the flexible silicone-based building material formed using the method of FIG. 1 used as a mortar between flooring material. Structure 200 includes a support floor or structure 202. A traditional mortar or concrete underlayer 204 is applied on the structure 202, and a flooring material 206 (such as ceramic tiles, bricks, flagstones, and the like) is applied onto and/or pressed into the concrete underlayer 204. Subsequently, the building material 210 is deployed into gaps or spaces 208 between the flooring material 206 to serve as a flexible grout.

In general, building material 210 is a silicone rubber that remains substantially flexible over a range of temperatures, adheres to the underlayer 204 and to the flooring material 206 to provide a water resistant seal. Further, the silicone rubber resists mold and is resistant to ultraviolet light, providing a material that can be used in outdoor areas such as walkways, poolside areas, and so on.

While the example of FIG. 2 presents the building material 210 as a mortar-type component that can be used as a coating/filler to fill spaces 208 between flooring material, the building material 210 may also be used in lieu of the underlayer 204. One possible example of the building material 210 used both under and between flooring material 206 is described below with respect to FIG. 3.

FIG. 3 is a cross-sectional view of a second example of a structure 300 including the flexible silicone-based building material 210 used as a mortar and including granular material 302. In this example, building material 210 is applied directly to the structure 202, and the flooring material 206 is pressed into the building material 210. In this example, the flooring material 206 includes an adhesive coating to assist in bonding the flooring material 206 to building material 210. The granular material 302 may be selected to provide color and texture to building material 210 to substantially match or to provide a desired contrast with respect to flooring material 206.

In some instances, prior to application of building material 210 to the structure 202, the structure 202 may be cleaned and the structure 202 may be treated with an adhesive to facilitate a bond between building material 210 and structure 202. In this instance, additional building material 210 may be added after the flooring material 206 is attached in order to fill spaces 208.

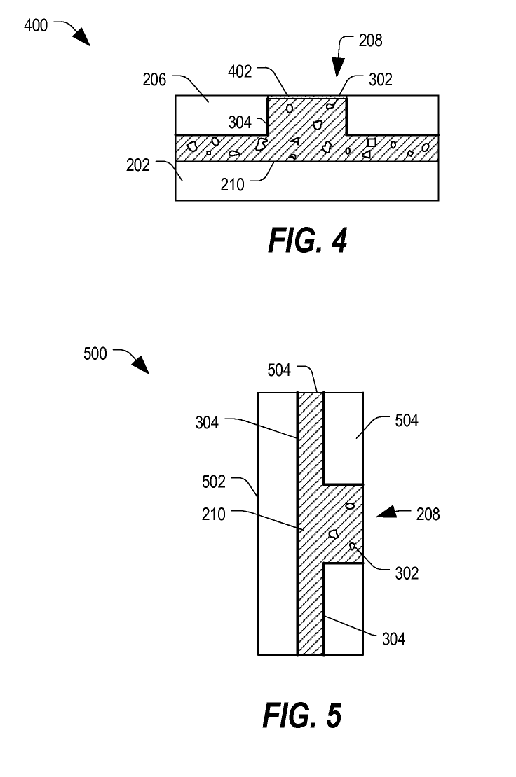

Building material 210 may provide a substantially clear finish that is glossier than adjacent surfaces. In such instances, it may be desirable to soften the appearance of the building material, such as by dusting or otherwise clouding the building material 210. One technique for clouding building material 210 may include thoroughly mixing sand, fine dust, or another colorant with the silicone rubber base and the catalyst. Another technique may include applying a layer of sand, fine dust, brick fragments, stone fragments, or colorant to an exposed surface of building material 210 before the cure process is complete. One possible example of a structure including such a coating is described below with respect to FIG. 4.

FIG. 4 is a cross-sectional view of a third example of a structure 400 including the flexible silicone-based building material 210 used as a mortar and including a surface coating 402. In this example, after application of flooring material 206 and prior to completion of the curing process of the building material 210, selected material is applied to the exposed surface of building material 210 to provide the surface coating 402.

Surface coating 402 may be selected to match adjacent flooring material or to contrast with adjacent flooring material. Surface coating 402 may include granules, rocks, glass beads, or other objects selected to provide a desired texture. Further, the durometer of surface coating 402 may be adjusted for a desired hardness. In an embodiment, surface coating 402 may be a paint or other colorant because latex and other paints will adhere to building material 210.

In some examples, flooring material 206 may be omitted, allowing building material 210 to be used as a coating. In one example, building material 210 may be used to coat a roof, for example, replacing shingles or other roofing materials. Small stones, rock dust, concrete dust, or other colorants may be embedded within or may be used as a coating 402 on such building material 210 to provide a desired appearance. In this instance, the building material 210 is thoroughly mixed with the desired colorant or granular material and, prior to completion of the curing process, building material 210 is spread substantially uniformly across a roof surface, providing a water proof, weather resistant, and appealing roofing material. Further, the building material 210 may be lighter than a standard roofing material, reducing the structural stresses caused by the weight of traditional roofing materials.

In another example where flooring material 206 is omitted, building material 210 may be used as a coating in lieu of stucco, paint, or other coatings. In particular, colorant may be mixed with the building material 210. Building material 210 may then be applied to exterior (or interior) walls of a structure, with varying thicknesses and/or varying directions-of-applications (e.g., swirls, straight lines, etc.) to provide a textured coating that is water resistant and resistant to deterioration in the presence of ultraviolet light. In a particular embodiment, taking advantage of the air-gap between wall surfaces of a wall, such as interior walls of a home, the coating may be applied on both sides of a wall in order to provide a sound damping function, reducing noise passage through interior and/or exterior walls of a structure.

While the examples of FIGS. 2-4 presented the building material 210 with respect to flooring and while the further examples presented the building material 210 as a versatile coating, it is also possible to utilize the building material 210 as an adhesive for bonding different materials on horizontal, sloped or vertical surfaces. One possible example of the building material 210 used as an adhesive on a vertical surface is described below with respect to FIG. 5.

FIG. 5 is cross-sectional view of a fourth example of a structure 500 including the flexible silicone-based building material 210 used as a mortar and configured to bond to a vertical substrate 502. Vertical substrate 502 may be a wall or other vertical structure. In one particular example, vertical substrate 502 may be a fireplace. In this example, vertical substrate 502 is prepared, such as by cleaning or roughening the surface. Adhesive 304 is applied to vertical substrate 502, and building material 210 is applied to adhesive 304. In this instance, adhesive 304 may assist building material 210 in adhering to vertical substrate 502, such as by providing an enhanced bonding interface that has fewer air pockets or openings that would be too small for the building material 210 to penetrate. In this instance, bricks 504 can be pressed into building material 210. As needed, additional building material may be disposed into spaces 208 between bricks 504.

In general, building material 210 secures bricks 504 to vertical substrate 502. Adhesive 304 may be omitted in some instances or may be used to enhance the bond between building material 210 and vertical substrate 502. Additionally, adhesive 304 may be applied to bricks 504 to enhance the bond between the bricks 504 and building material 210, as desired.

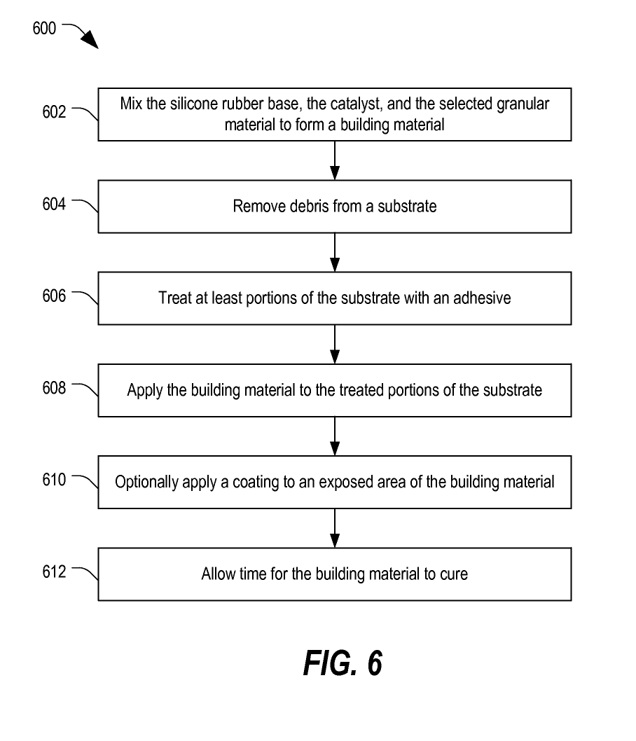

While the example of FIG. 5 is presented with bricks 504, other types of structural materials may be used, including stones, pebbles, glass beads or pieces, and/or other aesthetic or textural components or particles. In some instances, as discussed with respect to FIG. 4, it may be desirable to further coat or otherwise alter the exposed surfaces of building material 210. One possible example of a method of altering the exposed surfaces is described below with respect to FIG. 6.

FIG. 6 is a flow diagram of an embodiment of a method 600 of using the flexible silicone-based building material. At 602, the silicone rubber base, the catalyst, and the selected granular material are mixed to form a building material. The granular material may be selected based on color, size, texture, or any combination thereof. Advancing to 604, debris is removed from a substrate. Continuing to 606, at least portions of the substrate may be treated with an adhesive. One example of such an adhesive is a spray-on glue.

Moving to 608, the building material is applied to the treated portions of the substrate. For example, if the substrate is a vertical surface, the building material may be spread onto the vertical surface to form a substantially uniform layer. Continuing to 610, a coating is optionally applied to an exposed surface of the building material. The exposed surface may be spaces between bricks or stones or may be an entire surface. The coating may include dust, granular particles, pebbles, stones, or even pigment or paint. Proceeding to 612, the building material is allowed time to cure.

For example, when used as a roadway patch, the building material may need cure time before allowing vehicles to drive over it. In some instances, such as when the building material is used to patch a pot hole, it may be desirable to clear the hole of loose debris, spray the adhesive, and then pour the building material into the hole. Depending on the size of the hole, some of the debris may be collected and mixed with the building material, both to provide a color match and to provide additional filler material that reduces the amount of silicone rubber needed to complete the repair. Such filler material may reduce the amount of cure time needed, in part, because the total volume of the silicone rubber is reduced.

When used to attach stones or bricks to a fireplace, a supporting structure may be used to hold the bricks for a period of time until the building material is cured. When used to seal cracks in a pool or adjacent to areas that may be experience significant water exposure, it may be desirable to prevent water from contacting the building material until the cure process is complete.

Depending on the surface, small pebbles, pieces of glass, or other items may be pressed into the building material before the building material is completely cured. For example, such items can be used to form a mosaic and/or to provide texture to a walkway, for example.

In the examples provided above with respect to FIGS. 1-6, silicone rubber, a catalyst, and filler material are combined to form a flexible concrete, flexible mortar, or flexible adhesive building material. The resulting building material has increased flexibility, compressibility, and deformation properties as compared to concrete, while maintaining a durability and strength similar to concrete. The building material should be present in an amount that fills at least some of the pores in the adjacent materials to form a lasting attachment. In an example, ten parts by weight of silicone rubber base, one part by weight of catalyst, and at least one part by weight of filler material are combined to form the building material.

While the above examples have focused on using dust, concrete, stones, brick fragments, stone fragments, glass pieces, beads, and other types of materials to alter the appearance and or texture, it is also possible to use fibers, such as fiberglass, to enhance the tensile strength and/or durability of the building material.

Generally, vulcanization or hardening may occur at ambient temperature and no special heating is required. Preferably, the building material should be applied when the ambient temperature is at or above 50 degrees Fahrenheit to facilitate vulcanization. At lower temperatures, the building material can still be applied; however, the curing process may take longer. While conventional elastomers use water in the formulation, the resulting materials tend to be susceptible to breakdown when exposed to water and sunlight. Accordingly, the composition described above uses an inorganic composition, which tends to be resistant to water penetration and ultraviolet light degradation.

In some formulations, gravel, stone fragments, or cement may be used in conjunction with the building material (for example as the granular additive or filler material). The inclusion of such granular material imparts hardness and wear and abrasion resistance to the building material as well as contributing to the aesthetics. Generally, cement has relatively low shrinkage and expansion properties. When used as an expansion joint material, the building material is more compressible than concrete, providing a barrier to water intrusion that might lead to frost heaves during the winter while allowing for expansion of the concrete during warmer seasons. In an example, the building material is relatively heat resistant and is sufficiently flexible to expand and shrink in response to the expansion properties of the adjacent materials without tearing.

In general, the granular material may be any material that can mix with the silicone rubber and the catalyst, including, but not limited to, sand, aggregate, glass, silica, talc, carbon black, pebbles, stones, brick dust or shavings, fiberglass, other fibers, and the like. Further, these materials can be used as desired either alone or in various combinations of one or more of these materials. The specific granule sizes of the filler and the optimum amount to use can be determined by routine testing.

Additionally, in some instances, the shape of the granules may be controlled, such as by selecting or producing rounded granules to reduce the possibility of tearing due to edge wear, particularly in high traffic areas where heavy equipment or machines (such as cars, airplanes, and the like) may add additional stress to the building material. In an example, river rocks may be selected to provide smooth adhesion surfaces with limited serrations to prevent undesired cutting or tearing of the building material that might undermine the water barrier properties and lead to premature failure of the building material for its intended purpose.

Further, in some instances, the sizes of the granules may be controlled. For example, larger granules may reduce overall compressibility of the building material. Regardless of the type or size of the granular material, the resulting building material has a number advantages over conventional concrete materials including higher deformability, higher elasticity and flexibility, greater resistance to water penetration, increased strength of cohesion, increased corrosion resistance, increased resistance to low and high temperature variation, and so on.

In an example, the building material may be packed into a building material kit including a first container having a silicone rubber base material, a second container including a curing agent, and a third container including a granular material. The silicone rubber base material, the curing agent, and the granular material are configured to be mixed to form a flexible building material. In some instances, at least one of the second container and third container are sized to fit within the first container. In an example, the building material composition cures to form a water impermeable seal having a tensile strength greater than approximately 6.5 MPa, a tear strength greater than approximately 27 N/mm, and a hardness of approximately 40 points. A different durometer silicone may be selected to yield a different hardness or softness and to provide different tensile and tear strengths, depending on the intended application.

In conjunction with the methods and compositions described above with respect to FIGS. 1-6, a silicone rubber base, a catalyst, and a selected granular material (filler material) are mixed to form a flexible building material, which can be applied as a coating, a seal, a mortar, a bonding material, or any combination thereof. The building material may be used in conjunction with other materials, such as concrete, to provide expansion joints, seals, and the like.

Although the present invention has been described with reference to preferred embodiments, workers skilled in the art will recognize that changes may be made in form and detail without departing from the scope of the invention.

What is claimed is:

1. A building material kit comprising:
a first container including a silicone rubber base material;
a second container including a curing agent;
a third container including a granular material; and
wherein the silicone rubber base material, the curing agent, and the granular material are configured to be mixed to form a flexible building material.

2. The building material kit of claim 1, wherein at least one of the second container and third container are sized to fit within the first container.

3. The building material kit of claim 1, wherein the flexible building material is configurable to bond a construction façade to a vertical structure.

4. The building material kit of claim 1, wherein the flexible building material is configurable to be used as a mortar.

5. The building material kit of claim 1, wherein the flexible building material cures at room temperature to form a water insoluble seal.

6. The building material kit of claim 1, wherein the granular material comprises rocks and rock particles.

7. The building material kit of claim 1, wherein the granular material is selectable to match at least one of a color and a texture of surrounding materials.

8. The building material kit of claim 1, wherein the silicone rubber base material comprises a silicon hydride-functional crosslinker and an inhibitor and wherein the curing agent includes a noble metal catalyst.

9. A method of forming a flexible building material, the method comprising:
adding a silicone rubber base material to a mixer in a quantity of 10 parts by weight;
adding a curing agent to the mixer in a quantity of less than two parts by weight;
selectively adding a granular material to the mixer; and
mixing the silicone rubber base material, the curing agent, and the granular material to form a flexible building material.

10. The method of claim 9, further comprising:
applying the flexible building material to a vertical surface; and
attaching a surface material to the flexible building material.

11. The method of claim 9, further comprising applying the flexible building material as grout between at least one of stones and tiles.

12. The method of claim 9, wherein a quantity of the granular material is selectable by a user to adjust one of a flexibility parameter and a compressibility parameter of the flexible building material.

13. The method of claim 9, wherein:
the silicone rubber base material includes a silicon hydride-functional crosslinker and an inhibitor; and
the curing agent includes a noble metal.

14. The method of claim 9, wherein the flexible building material is water resistant.

15. A silicone mortar comprising:
a silicone rubber base in a quantity of approximately ten parts by weight;
a curing agent in a quantity of approximately one-to-three parts by weight; and
a granular material in a quantity of at least one part by weight.

16. The silicone mortar of claim 15, wherein the granular material provides a texture and a color to the silicone mortar.

17. The silicone mortar of claim 15, wherein the silicone rubber base is a room temperature vulcanizing (E RTV) Silicone Rubber.

18. The silicone mortar of claim 15, wherein the silicone rubber base, the curing agent, and the granular material are mixed to form a building material composition.

19. The silicone mortar of claim 18, wherein the building material composition is configurable to bond a façade material to a surface.

20. The silicone mortar of claim 18, wherein the building material composition cures to form a water impermeable seal having a tensile strength greater than approximately 6.5 MPa, a tear strength greater than approximately 27 N/mm, and a hardness of approximately 40 points.
